(19) United States
(12) Patent Application Publication
(10) Pub. No.: US 2012/0012535 A1
(43) Pub. Date: Jan. 19, 2012

(54) OIL SKIMMER CONVEYOR

(75) Inventor: Timothy Wayne Taylor, Decatur, AL (US)

(73) Assignee: Oil Busters, LLC, Decatur, AL (US)

(21) Appl. No.: 13/184,632

(22) Filed: Jul. 18, 2011

Related U.S. Application Data
(60) Provisional application No. 61/365,641, filed on Jul. 19, 2010.

(51) Int. Cl. E02B 15/10; C02F 1/00; C02F 101/32

(52) U.S. Cl. 210/747.6; 210/242.3; 210/196

(57) ABSTRACT

An oil skimmer conveyor includes an inclined frame attached to a boat or other structure. Upper and lower rollers are connected to the frame, and a continuous belt is supported by the rollers. The lower roller extends into the water, and is at least partially submerged in water. The belt is more permeable to water than to oil, and rotates about the rollers. Water passes through the belt, and oil is carried out of the water by the belt and collected in the boat.

The present application claims priority from provisional U.S. Patent Application 61/365,641, filed Jul. 19, 2010.

### FIELD OF THE DISCLOSURE

The present disclosure relates generally to the field of fluid separation. In particular, the present disclosure relates to a device and method of mechanically separating oil from water. More particularly, the disclosure describes the use of an inclined conveyor to remove oil from water.

### BACKGROUND OF THE DISCLOSURE

On Apr. 20, 2010, an explosion involving the Deepwater Horizon drilling rig in the Gulf of Mexico killed 11 platform workers and caused a sea floor oil gusher that discharged large quantities of crude oil into the Gulf. The environmental impact of this oil spill was catastrophic, and there have been many other oil spills into the waters of the United States and other countries. People continue to use large quantities of oil, and there will almost certainly be other oil spills in the future. There exists a need to develop technology to remove oil from open waters and waterways as quickly as possible to minimize and mitigate the damage from future oil spills.

Current approaches to remove oil from water include burning, filtering and collecting, absorption, and bioremediation. This disclosure describes a process to filter and remove oil from the water. The current invention could also be used to separate water from other compounds that form a layer on top of water, such as non-polar solvents. The filtered oil (or other material) should be temporarily stored for later use or disposal. A filter system should quickly and efficiently remove oil floating on the top of water bodies, where the separated oil should be largely free of water to minimize the quantity of material that must be stored.

### SUMMARY OF THE INVENTION

The present disclosure is directed to a system and apparatus for removing oil from water. In its basic form, the system comprises an oil skimmer conveyor for oil and water which lifts oil off of the surface of the water to be collected and stored. The system comprises an inclined frame with at least two rollers on opposite ends, and a continuous belt supported by the rollers. One or more of the rollers may be connected to a drive to rotate the belt about the rollers.

In order to remove oil from water, one end of the frame is placed at an inclined angle into the surface of the water such that a lower roller is at least partially submerged. Next, the drive is engaged to rotate the rollers, thereby causing the belt to rotate about the rollers. The belt is more permeable to water than to oil, so water passes through the belt and oil travels up the belt to a scraper. The scraper removes the oil from the belt, and deposits the recovered oil in a scraper catch pan.

The frame is mounted to a boat or other structure by a pivot mount such that the frame can pivot about the pivot mount Floats are connected to the frame near the lower roller to maintain the lower roller at a relatively constant depth in the water. The pivot mount allows the frame to pivot with incoming waves such that the frame adjusts its position to keep the lower roller at a relatively constant depth.

### BRIEF DESCRIPTION OF THE DRAWINGS

The present disclosure is described with reference to the accompanying drawings. In the drawings, like reference numbers indicate identical or functionally similar elements. The elements of the drawings are not necessarily to scale, emphasis instead being placed upon clearly illustrating the principles of the disclosure.

FIG. 1 is a top view of the oil skimmer conveyer according to one embodiment of the present disclosure, with the belt removed to show the underlying components.

FIG. 2 is a top perspective view of one embodiment of the oil skimmer conveyer mounted on a boat.

FIG. 3 is a side view of one embodiment of the oil skimmer conveyor mounted on a barge being pushed by a tug boat.

FIG. 4 is a top perspective view of one embodiment of the oil skimmer conveyor.

FIG. 5 is side view of the oil skimmer conveyor mounted on a boat, with selected internal portions shown in dashed lines

FIG. 6 is a top view of the oil skimmer conveyor with selected internal portions shown in dashed lines.

FIG. 7 is a side view of the oil skimmer conveyor with the near side frame element removed to better show the internal components.

FIG. 8 is a side view of the oil skimmer conveyor mounted on a boat, with hidden portions of the water drain pan shown in dashed lines.

### DETAILED DESCRIPTION

For purposes of summarizing the disclosure, certain aspects, advantages, and novel features of the disclosure have been described herein. It is to be understood that not necessarily all such advantages may be achieved in accordance with any one particular embodiment of the disclosure. Thus, the disclosure may be embodied or carried out in a manner that achieves or optimizes one advantage or group of advantages as taught herein without necessarily achieving other advantages as may be taught or suggested herein.

### The Boat

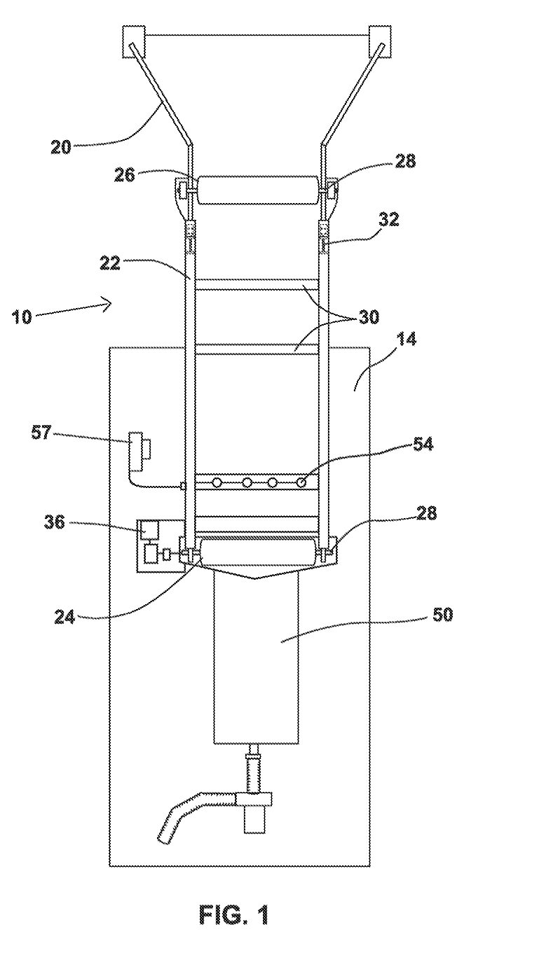

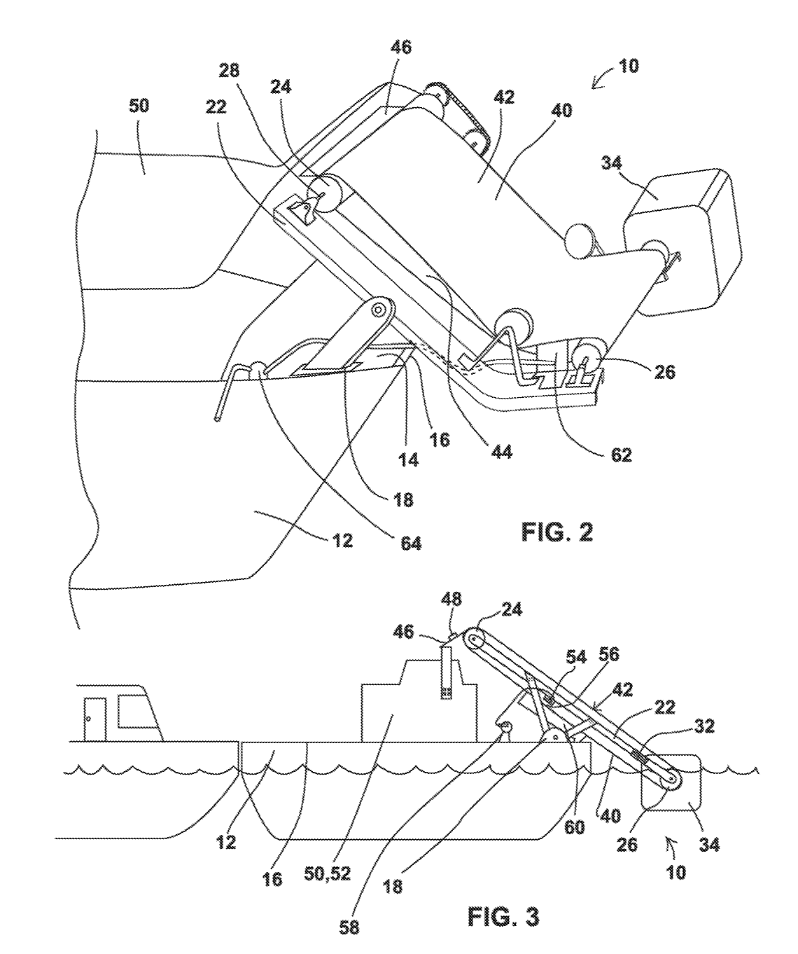

An oil skimmer conveyor 10 can be positioned on a boat 12, as seen in FIGS. 1-3. The conveyor 10 is designed to remove oil floating on top of water bodies, so positioning the conveyor 10 on a boat 12 provides a convenient means of transporting and positioning the conveyor 10 on bodies of water. However, the oil skimmer conveyor 10 can also be positioned on land adjacent to a body of water, as desired. The oil skimmer conveyor 10 may be useful in a fixed position on settling ponds or other bodies of water where one expects surface oils that should be removed. The oil skimmer conveyor 10 could also be mounted to a truck or other wheeled vehicle, and parked next to a body of water for use. The description primarily describes the conveyor 10 connected to a boat 12, but the principles described also apply to embodiments where the conveyor 10 is land-based.

Oil slicks can be moved or carried by currents or wind, so the ability to position the conveyor 10 can help to increase efficiency by facilitating placement of the conveyor 10 where oil slicks are thickest, or where oil slicks present the largest threat to environmentally sensitive areas. The oil skimmer conveyor 10 can be positioned in a desired location by either mounting it on a boat 12, or by mounting it on a mobile land-based device that can be moved to different locations along the shore, or by positioning the oil skimmer conveyor 10 downwind from the prevailing winds, or even by providing secondary means for directing surface oil to the oil skimmer conveyor 10.

The term “boat” 12, as used in this description, is defined to mean a man made vessel which floats on the water and can be propelled to different locations. The term boat 12 is intended to include ships, tug boats, sail boats, or other vessels which include a means of propulsion (such as a motor, sail, or oars), as well as barges and other vessels which may not include a means of propulsion, and must be moved by other boats (such as a tug boat.) The boat 12 can include other components that may support the operation of the conveyor 10, such as crew quarters, holding tanks, electrical generators for power, etc. The boat 12 should be large enough to safely hold and operate the conveyor 10.

The boat 12 has a deck 14 and a gunwale 16. In one embodiment, the conveyor 10 is mounted to the deck 14 of the boat 12 with a pivot mount 18, where the pivot mount 18 is secured to the deck 14 and to the conveyor 10. In other embodiments, the conveyor 10 can be mounted in a recess below the deck 14, which can provide weather protection. In either case, the conveyor 10 is pivotally mounted to the boat 12 with a pivot mount 18 such that the conveyor 10 can pivot and move independent from the motion of the boat 12. There can also be an enclosure positioned over the conveyor 10 on the deck 14 for weather protection. The conveyor 10 is mounted to the boat 12 at an incline such that a portion of the conveyor 10 extends beyond the gunwale 16 of the boat and reaches downward to the water. The conveyor 10 can extend beyond the gunwale 16 from below the deck 14 if the conveyor 10 is positioned in a recess below the deck 14.

The boat 12 can also include one or more booms 20 extending from the boat 12, or extending from the conveyor 10 itself. In a preferred embodiment, the conveyor 10 includes a boom 20 extending at an angle from each side of the conveyor 10, so movement of the boat 12 towards the point where the conveyor 10 extends beyond the gunwale 16 will funnel surface liquids towards the conveyor 10. In this embodiment the two booms 20 may be connected with a cable, rod, or net at a point outward of the gunwale, so that debris can be blocked from the conveyor 10, or to secure the booms 20 relative to each other. In alternate embodiments, the boat 12 can include a single boom 20, or more than one boom.

### The Conveyor Frame

The conveyor 10 comprises a frame 22, with an upper roller 24 and a lower roller 26 secured to the frame such that the upper and lower rollers 24, 26 can rotate about a roller axis 28. In use, the conveyor 10 is inclined so the upper roller 24 is positioned higher than the lower roller 26. The frame 22 can be made of steel, aluminum, or other metals, as well as wood, polymeric materials, or essentially any material which can support the weight and operations of the various components of the conveyor 10. In one embodiment, the frame 22 is metallic, and can be angle bar or “U” bar. There can be bearings for connecting the upper and lower rollers 24, 26 to the frame 22.

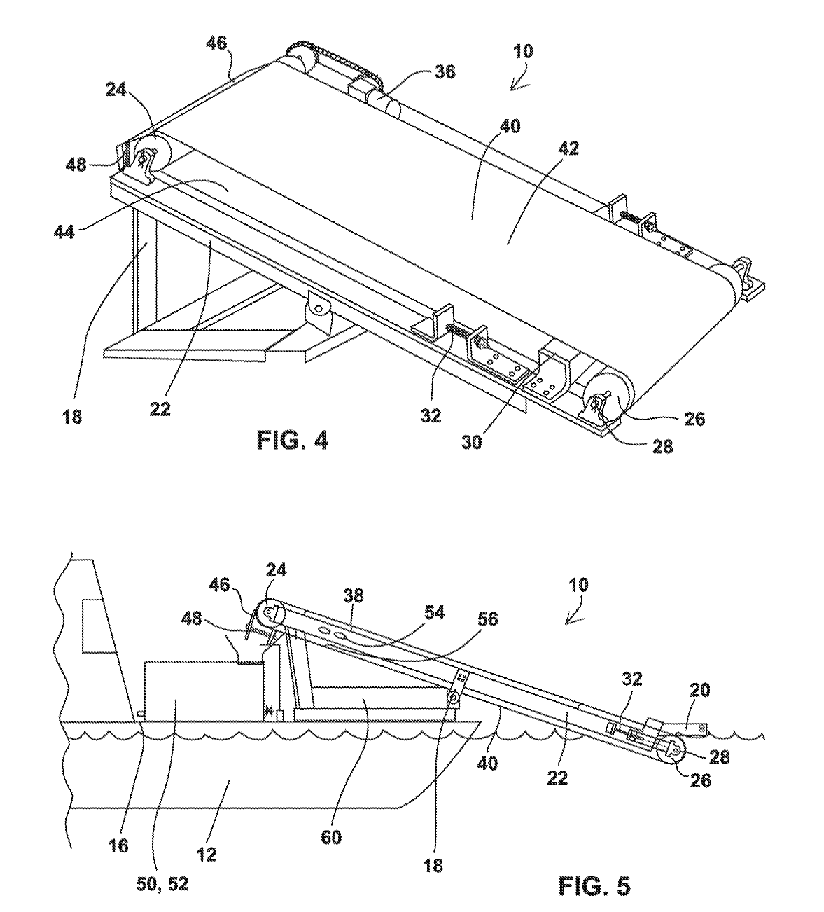

The frame 22 can be as simple as two essentially straight lengths of metal secured together in a parallel relation. As shown in FIG. 4, with continuing reference to FIGS. 1-3, one or more cross bars 30 can secure the straight lengths of metal together to form an essentially square box frame, with ends protruding beyond the box frame for the upper and lower rollers 24, 26. In other embodiments, the frame 22 can be more complex. In some embodiments, the frame 22 can support more than two rollers. For example, the frame 22 can include an angle, so the lower portion of the frame 22 is essentially level with the surface of the water, and the upper portion of the frame 22 inclines upward to the upper roller 24, and there is a third roller positioned at the point where the frame 22 is angled. Many other frame 22 shapes and roller configurations are also possible.

The frame 22 can include one or more tension adjustors 32 to adjust the relative position of the upper and lower rollers 24, 26. When the frame 22 includes a tension adjustor 32, the frame should include separate but connected components for the upper roller 24 and the lower roller 26, so that each roller 24, 26 can move relative to the other. There can be one tension adjustor 32 which moves an entire roller relative to the other, or there can be two or more tension adjustors 32 so not only the distance between the rollers 24, 26 can be adjusted, but the relative angle of the rollers 24, 26 can also be adjusted. If there are more than two rollers 24, 26, there can be different tension adjustors 32 for each roller, or there can be one tension adjustor 32 that controls the tension for several different rollers.

Many different types of tension adjustors 32 are available, as is understood by one skilled in the art. The tension adjustor 32 changes the relative position of two different frame portions, such as portion A and portion B, where portion A and B can be adjacent and adjustably connected. For example, the tension adjustor 32 can include a threaded receptacle fixed to portion A, a threaded rod received in the threaded receptacle, and a rotating receptacle in portion B such that rotation of the threaded rod moves the adjacent frame portions relative to each other. In an alternate embodiment, a clamp system can be used in place of the threaded rod, so the clamp can fix or release the relative position of portions A and B. In an yet another embodiment, the tension adjustor 32 can be hydraulic cylinder, where one end of the piston rod is secured to portion A, and the cylinder head is fixed to portion B such that movement of the piston rod in and out of the cylinder head moves the relative position of the frame portions. Other tension adjustors 32 are also possible.

Many different components can be connected to the frame 22. For example, the pivot mount 18 can be pivotally connected to the frame 22 so the conveyor 10 can move independent of the motion of the boat 12. If the conveyor 10 is mounted on land, the pivot mount 18 may be optional because the water body may have minimal wave action. One or more floats 34 can be connected to the frame 22 at a point close to the lower roller 26, where the floats can be used to maintain the lower roller 26 at a relatively constant depth in the water, regardless of wave action. The buoyancy of the floats 34 may be adjustable, so the depth of the lower roller 26 can be changed for different conditions or different types of oil clean-up. The pivotal connection of the frame 22 to the boat 12 combined with floats 34 connected to the frame near the lower roller 26 enable the conveyor 10 to maintain a relatively constant position in the water despite wave action or other water disturbances.

A drive 36 can also be connected to the frame 22, where the drive 36 rotates one or more rollers. The drive 36 is connected to at least one roller, and by connected by chains, belts, shafts, or other devices known to those skilled in the art. In one embodiment, the drive 36 is an electric motor, and there can be gears or sprockets to control the rotation rate of the drive roller, as is understood by one skilled in the art. The drive 36 can also be a gasoline engine, or it could even be a manual crank, or any other device for rotating a roller. The drive 36 can be mounted to the frame 22, but it is also possible for the drive 36 to be mounted to other components. For example, the drive 36 could be mounted to the pivot mount 18, or even to the deck 14. A drive belt and tension spring system could be used for a drive 36 mounted somewhere other than to the frame 22. The drive 36 provides the force to rotate a roller, so the position of the drive is not critical. In some embodiments, the drive 36 can rotate more than one roller, or there can be more than one drive 36 for the same or different rollers. If more than one roller is powered by a drive 36, the relative rotation of the different rollers should be synchronized so all rollers work together.

The frame 22 can include a belt support 38, which can be positioned at or near the upper tangent line for both the upper and lower rollers 24, 26, as indicated in FIG. 5, with continuing reference to FIGS. 1-4. A fabric or flexible material passing around the rollers would then rest on the belt support 38, so spans of the flexible material would be shorter. The belt support 38 could pass completely across the length of the rollers 24, 26, or it could extend a set distance from each side of the frame 22 so a flexible material passing between the rollers 24, 26 would be supported on the edges, but not in the middle. Other embodiments of the belt support 38 are also possible, as is understood by one skilled in the art.

### The Belt

A continuous belt 40 is supported by the upper and lower rollers 24, 26 and rotates about the upper and lower rollers 24, 26 as they spin. The belt 40 is continuous in that is makes a loop, so as the rollers 24, 26 spin, the belt 40 continuously rotates between the rollers 24, 26. The belt 40 has a belt outer surface 42 opposite a belt inner surface 44, where the belt inner surface 44 directly contacts the rollers 24, 26. In operation, the belt 40 is generally rotated such that a point on the belt 40 approaches and makes contact with the bottom side of the lower roller 26 and separates and moves away from the top side of the lower roller 26. This means the belt 40 tends to retain material and carry it from the water towards the upper roller 24 on the upper or top side of the conveyor 10.

The belt 40 is more permeable to water than to oil, so water will pass through the belt 40 more quickly than oil. In some embodiments, the belt 40 is a papermachine forming belt, and in one particular embodiment the belt 40 is papermachine forming fabric Model Number PB577 manufactured by Albany Felt. However, any semi-permeable fabric, mesh, or screen capable of adhering or retaining oil to its surface while allowing water to pass through may be used. In one embodiment, the oil will actually adhere to the belt 40 to some extent, which facilitates the oil traveling up the conveyor's incline as the belt 40 rotates. A belt that oil adheres to can facilitate the oil and water separation because the oil will have less of a tendency to flow down the incline as the belt 40 rotates.

### Oil Collection

The belt 40 is rotated through oil contaminated water, and oil is carried up the incline of the conveyor 10. A scraper 46 is used to help remove the oil from the belt 40. The scrapper 46 is held in contact with the belt outer surface 42, preferably at an obtuse angle relative to the belt 40 with oil approaching the scrapper 46. The scrapper 46 can be positioned at many points along the belt 40, but preferably the scrapper 46 is positioned in contact with the belt outer surface 42 at a point along the circumference of the upper roller 24. The belt 40 bends along the upper roller 24, and this bending motion can tend to help separate materials from the belt 40. Positioning the scrapper 46 at this point can increase the effectiveness of the scrapper 46 in removing oil from the belt 40.

A scrapper tensioner 48 can hold the scrapper 46 against the belt outer surface 42. The scrapper tensioner 48 can be a spring system that urges the front edge of the scrapper 46 against the belt 40, but other systems can be used as well. For example, the scrapper tensioner 48 can use air pressure or weights and gravity to urge the front edge of the scrapper 46 against the belt 40.

The oil is removed from the belt 40 by the scrapper 46, and the removed oil falls into a scrapper catch pan 50 positioned below the scrapper 46. The scrapper catch pan 50 has an opening positioned under the scrapper 46, and gravity pulls the oil from the scrapper 46 into this opening. The scrapper catch pan 50 opening can be positioned close to the scrapper 46, to minimize spills due to wind, rocking of the boat 12, or other disturbances, or the scrapper catch pan 50 opening can be large to account for variations in the flow of oil coming off the scrapper 46. There can also be chutes, funnels, or other devices to direct the oil into the scrapper catch pan 50.

Once the oil is removed from belt 40, the recovered oil can be passed through an oil/water separator 52 to remove water which may have entered the scrapper catch pan 50. The scrapper catch pan 50 can be an oil/water separator 52, or the scrapper catch pan 50 and the oil/water separator 52 can be separate tanks. Water can be entrained with the oil, or water can spray into the scrapper catch pan 50, but an oil/water separator 52 can help reduce the volume of water, and thereby reduce the volume of removed oil (with any remaining water) that must be stored as the oil skimmer conveyor 10 works.

Oil/water separators 52 are known to those skilled in the art, and typically include an oil outlet near the top of the tank and a water outlet near the bottom of the tank. A probe can be used to detect the interface between the oil and water, and the amount of material removed from the oil outlet and the water outlet can be adjusted to keep the interface within a desired range. A conductivity probe can be used to detect the interface, but several other probes or visual aids can also be used. Fluids in the oil/water separator 52 typically are allowed to stand stagnant for a period of time to separate, and there can be baffles and other internal structures to limit agitation and aid in separation. The oil collected from the oil/water separator 52 can then, be stored in a holding tank on the boat 12 until it is off-loaded. The holding tank can also be in an adjacent boat, such as an adjacent barge or a tanker, as desired.

### The Spray Nozzle

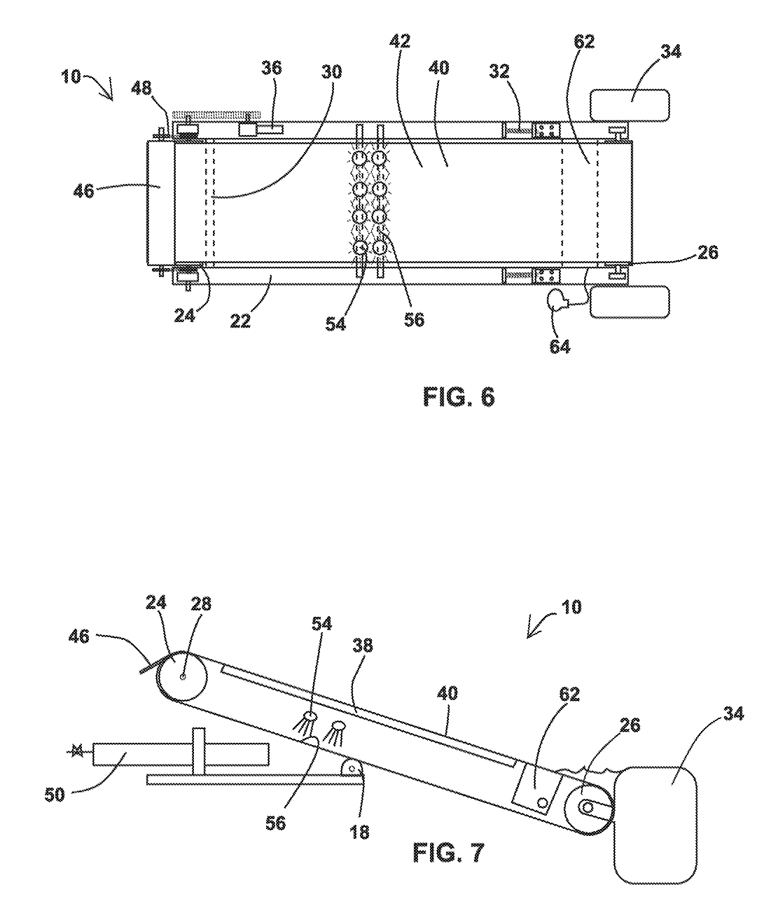

The belt 40 may retain some oil or other debris that is not removed by the scrapper 46, and a spray nozzle 54 can help remove this residual material, as shown in FIGS. 6 and 7, with continuing reference to FIGS. 1-5. Residual oil and other debris remaining on the belt 40 can plug the pores and gaps such that water passage through the belt 40 is slowed, and the residual oil can reduce the amount of new oil that adheres to the belt 40. This can reduce the efficiency of the belt 40, so a method of cleaning or washing the belt 40 may be desirable.

The spray nozzle 54 can be positioned to spray a fluid onto the belt 40 at a wash point 56. The wash point 56 can be on the belt outer surface 42, but in some embodiments the wash point 56 is on the belt inner surface 44. Spraying fluid onto the belt inner surface 44 backwashes the belt 40, so oil or other debris is urged out of the belt 40 from the same direction as it entered the belt 40. Backwashing can be effective for cleaning, because the oil does not have to pass completely through the belt 40.

The fluid used in the spray nozzle 54 can be air, and an air compressor 57 can be used to power the spray nozzle 54. In an alternate embodiment, the fluid can be a liquid, such as water, and a nozzle pump 58 can supply fluid to the spray nozzle 54. Many different liquids can be used in the spray nozzle 54, but water has several advantages. Water is readily available and very inexpensive on a boat 12, and there are no new corrosion or cross-contamination issues because the belt 40 is already exposed to water. Water is not toxic or flammable, which makes it a safe choice for a wash fluid. The belt 40 is designed to be permeable to water, so water will pass through the belt 40 to facilitate the backwashing process. For these reasons, water is a good option for the wash fluid used in the spray nozzles 54. The wash fluid can contain additives, such as surfactants, to improve the washing process.

A nozzle catch pan 60 can be positioned below the wash point 56 to collect liquids and other debris that may be washed from the belt 40 by the spray nozzle 54. The nozzle catch pan 60 should have an opening for catching liquids from the belt, and the nozzle catch pan 60 opening can be positioned close to the belt to minimize spillage losses from wind, rocking of the boat, or other disturbances. In some embodiments, the nozzle catch pan 60 opening extends for some distance under the belt 40, because it may take some time for wash liquids to pass through the belt and drip down, and some liquids may adhere to the belt 40 for some time before dripping down.

Wash liquid collected in the nozzle catch pan 60 can be recirculated repeatedly through the spray nozzle 54. The inlet to the nozzle pump 58 can be connected to the nozzle catch pan 60, and the outlet is connected to the spray nozzle 54, so wash fluid can be continuously recirculated. This can save on costs for additives in the wash fluid, because the additives are re-used. The nozzle catch pan 60 can include upper and lower outlets for selectively removing oil or water, respectively, which can help minimize contamination of the spray nozzle 54 with oil by limiting the build-up of oil in the nozzle catch pan 60. Therefore, the nozzle catch pan 60 can be used as an oil and water decanter. The removed oil can then be added to the oil collected by the scrapper catch pan 50.

### Water Discharge

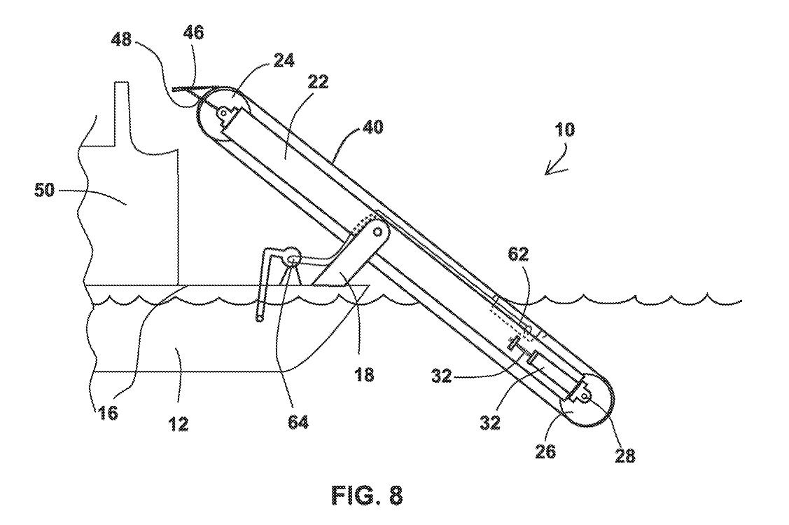

Water that is separated from the oil can be returned to the water body that the boat 12 is floating on. This can include water from the oil/water separator 52, as well as wash water from the spray nozzle 54 that passes through the belt 40. In one embodiment, the conveyor comprises a water drain pan 62 abutting the belt inner surface 44 near the lower roller 26, as shown in FIG. 8, with continuing reference to FIGS. 1-7. In some embodiments, the water drain pan 62 is positioned such that at least some of the belt 40 directly over the water drain pan 62 is below the surface of the water. In other embodiments, the belt 40 directly over the water drain pan 62 is above the surface of the water. In various embodiments, the water drain pan 62 can extend along much or all of the length of the belt 40, there can be one or multiple water drain pans 62, the water drain pan 62 can be at essentially any position along the length of the belt 40, and the water drain pan 62 can even be a generally sealed area around the entire belt inner surface 44.

The inlet, suction side of a drain pan pump 64 can be connected to the water drain pan 62, so water in the drain pan 62 is pumped out by the drain pan pump 64. The water drain pan 62 can make at least a partial seal with the belt inner surface 44, so the water drain pan 62 creates some vacuum on the belt inner surface 44 as water is pumped out of the water drain pan 62. The vacuum created by the drain pan pump 64 urges water to pass through the belt 40, and can increase the rate of separation of water and oil on the belt 40. The vacuum can thereby allow for faster belt rotation rates, and faster separation of water and oil. In alternate embodiments, the drain pan pump 64 can evacuate gases from the water drain pan 62 to pull a vacuum. In general, the drain pan pump 64 evacuates fluids from the water drain pan 62, where fluids include both gases and liquids.

The water from the water drain pan 62 can be pumped directly back into the body of water the boat 12 is floating on, or it can be processed prior to discharge back to the water body. The belt 40 filters the oil from the water before the water flows into the water drain pan 62, so the water discharged from the water drain pan 62 has less oil than before filtration. Possible treatment methods include further filtration, passing the water through a decanter to further separate the oil and water, or other methods.

In alternate embodiments, vacuum can be supplied to the belt inner surface 44 by other methods, as is understood by one skilled in the art. For example, the suction side of a vacuum pump could be connected to a water drain pan 62 under the belt 40, where the water drains out of the water drain pan 62 at a water discharge point, and the vacuum pump draws gases out of the water drain pan 62 at a gas discharge point which is positioned above the water level such that most discharged water is not drawn into the gas discharge point. In this embodiment, the vacuum pump could be the drain pan pump 64. It is also possible to use a vacuum pump that draws liquids out of the water drain pan 62 as the drain pan pump 64. There are also other devices besides vacuum or water pumps to evacuate either water or gases from the water drain pan 62, including but not limited venturi devices such as ejectors, and possibly even sealed drain tubes that use the weight of water in a down leg to pull vacuum.

### CONCLUSION

The separation and collection of oil spilled onto water bodies is important to the environmental health of an area, and also can have significant impacts on tourism, fishing, and other industries which depend on safe, clean water. People use large quantities of oil, so there will almost certainly be accidents that spill oil onto our waters. The oil skimmer conveyor described herein can help mitigate oil spills, and may reduce any environmental or economic damage that can result from an oil spill.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

1. An oil skimmer conveyor for oil and water comprising:
an upper roller and a lower roller;
a frame supporting the upper roller and the lower roller, where the frame is inclined such that the lower roller is lower than the upper roller;
a continuous belt supported by the rollers, where the belt has a belt outer surface and a belt inner surface, where the belt inner surface contacts the lower roller and the upper roller, and where the belt is more permeable to water than to oil;
a pivot mount pivotally connected to the frame;
means for adjusting the position of the upper roller and lower roller relative to each other;
a scraper positioned to contact the continuous belt;
a scraper catch pan positioned below the scraper;
a drive connected to at least one roller;
a float connected to the frame near the lower roller;
a water drain pan contacting the belt inner surface near the lower roller, where the water drain pan forms at least a partial seal with the belt; and
a drain pan pump connected to the water drain pan.

2. The conveyor from claim 1 further comprising a boat having a gunwale, the boat connected to the pivot mount such that the lower roller extends beyond the gunwale and is at least partially submerged.

3. The conveyor from claim 1 further comprising a scraper tensioner connected to the scraper, where the scraper tensioner urges the scraper towards the belt.

4. The conveyor from claim 1 where the frame further comprises a belt support positioned along the upper tangent line for both the upper and lower roller such that the belt rests on the belt support.

5. The conveyor of claim 1 further comprising a boom extending from the conveyor, where the boom angles outward from the conveyor to urge surface liquids towards the conveyor.

6. The conveyor of claim 1 further comprising a spray nozzle positioned to spray water onto the belt inner surface at a wash point.

7. The conveyor of claim 6 further comprising a nozzle catch pan positioned below the wash point.

8. The conveyor of claim 7 further comprising a nozzle pump to recirculate water from the nozzle catch pan to the spray nozzle.

9. An oil skimmer conveyor for oil and water comprising:
an upper roller and a lower roller;
a frame connected to the upper and lower roller, where the frame is inclined such that the lower roller is lower than the upper roller;
a continuous belt supported by the rollers, where the belt has a belt outer surface and a belt inner surface, where the belt inner surface contacts the lower roller and the upper roller, and where the belt is more permeable to water than to oil;
a pivot mount pivotally connected to the frame;
a tension adjustor connected to the frame for adjusting the position of the upper roller and lower roller relative to each other;
a scraper positioned to contact the continuous belt;
a scraper catch pan positioned below the scraper;
a drive connected to at least one roller for rotating the belt;
a float connected to the frame near the lower roller;
a spray nozzle positioned to spray fluid onto the belt such that the spray contacts the belt at a wash point, and;
a nozzle catch pan positioned below the wash point.

10. The conveyor of claim 9 further comprising a boat having a gunwale, where the boat is connected to the pivot mount such that the lower roller extends beyond the gunwale and is at least partially submerged.

11. The conveyor from claim 9 further comprising a nozzle pump with a nozzle pump inlet connected to the nozzle catch pan and a nozzle pump outlet connected to the spray nozzle such that liquids collected in the nozzle catch pan are sprayed from the spray nozzle.

12. The conveyor from claim 11 further comprising a nozzle catch pan oil drain port positioned near the top of the nozzle catch pan such that accumulated oil can be drained from the nozzle catch pan, and a nozzle catch pan water drain port positioned near the bottom of the nozzle catch pan such that accumulated water can be drained from the nozzle catch pan.

13. The conveyor from claim 9 further comprising an air compressor connected to the spray nozzle, such that the fluid discharged from the spray nozzle is air.

14. The conveyor from claim 9 further comprising an oil/water separator connected to the scraper catch pan.

15. The conveyor from claim 9 further comprising a scraper tensioner connected to the scraper, where the scraper tensioner urges the scraper towards the belt.

16. The conveyor from claim 9 where the wash point is on the inner belt surface.

17. The conveyor from claim 9 further comprising a water drain pan contacting the belt inner surface near the lower roller, and a drain pan pump connected to the water drain pan, where the water drain pan forms a seal with the belt and the drain pan pump evacuates fluids from the water drain pan such that a slight vacuum is formed in the water drain pan to urge liquids through the belt into the water drain pan.

18. A method for separating oil from water comprising:
(a) providing an inclined frame connected to an upper roller and a lower roller rotatably mounted on a roller axis;
(b) supporting a continuous belt on the upper and lower roller such that a belt inner surface directly contacts the upper and lower roller;
(c) mounting the frame to a boat with a pivot mount such that the frame pivots about the pivot mount, and where the pivot mount is positioned such that the lower roller is positioned beyond a boat gunwale in an at least partially submerged position;
(d) connecting a float to the frame near the lower roller such that the lower roller is buoyed to a certain height in the water by the float, so the frame can pivot with waves to maintain the lower roller at approximately a constant depth in the water;
(e) rotating at least one roller with a drive so the belt rotates about the upper and lower rollers;
(f) evacuating fluids from a water catch pan to create at least a partial vacuum in the water catch pan, where the water catch pan contacts the belt inner surface;
(g) collecting water passing through the belt in the water catch pan;
(h) removing oil from the belt with a scrapper positioned to contact the belt; and
(i) collecting oil from the belt in a scrapper catch pan positioned below the scrapper.

19. The method of claim 18 further comprising:
connecting a boom to the boat on each side of the conveyor such that the booms angle outward from the conveyor; and
driving the boat in the direction the belt extends past the boat such that surface liquids are urged toward the conveyor by the booms and the motion of the boat.

20. The method of claim 18 further comprising:
(j) washing the belt with a spray nozzle positioned to spray a fluid onto the belt at a wash point, and;
(k) collecting fluid in a nozzle catch pan positioned below the wash point.

21. The method of claim 18 further comprising adjusting the buoyancy of the float to control the position of the lower roller in the water.
